(19) United States
(12) Patent Application Publication
(10) Pub. No.: US 2022/0192071 A1
(43) Pub. Date: Jun. 23, 2022

(54) SPACE-OPTIMIZED DISC HARROW

(71) Applicant: Lemken Gmbh & Co KG, Alpen (DE)

(72) Inventors: Ludger Maas, Sonsbeck (DE); Clemens Diepers, Aldekerk (DE); Georg Paulessen, Willich (DE)

(21) Appl. No.: 17/604,344

(22) PCT Filed: Apr. 15, 2020
(86) PCT No.: PCT/DE2020/100305

§ 371 Date: Oct. 15, 2021

(30) Foreign Application Priority Data
Apr. 15, 2019 (DE) 10 2019 205 437.4

(51) Int. Cl. A01B 35/16; A01B 73/04

(52) U.S. Cl. CPC A01B 35/16; A01B 73/044

(57) ABSTRACT

The present application relates to a soil tillage implement (10) having soil tillage tools (28), in particular disc tools, which are arranged in multiple tool rows (30.1 . . . 30.3) following one another in the working direction (A) and which are oriented transversely to the working direction (A), and having a running gear with at least one main wheel (20.1, 20.2), which is spaced apart from a centre longitudinal axis (22) transversely to the working direction (A) by a lateral wheel distance (dr). Here, the running gear is arranged with respect to the soil tillage tools (28) in such a manner that with respect to the working direction (A) in front of and to the left and right of the running gear at least one soil tillage tool (28) is arranged. All soil tillage tools (28) which are arranged in the tool row (30.1) located furthest in front of the running gear in the working direction (A) have a lateral tool distance (dw) from the centre longitudinal axis (28) that is smaller than or equal to the lateral wheel distance (dr).

The present invention relates to a soil tillage implement with soil tillage tools, in particular disc tools, which are arranged in multiple tool rows following one another in the working direction oriented transversely to the working direction, and a running gear having at least one main wheel.

The present invention generally relates to a soil tillage implement that can be pulled over the ground with a tow bar behind a tractor in order to till the soil. In particular, the soil tillage implement can be a disc harrow, wherein the invention described in the following can also be applied to similar soil tillage implements, i.e. soil tillage implements with similar construction and/or similar arrangement of soil tillage tools, for example of six discs, hollow discs, cross-cutters, rollers, clearing blades or star discharge rotors, levelling tools or cross-boards. The soil tillage implement is supported by a height-adjustable running gear which can also be employed in order to transport the soil tillage implement in a transport position on public roads between various places of operation.

Generally, mechanisms, for example traction boosters, with which the force or weight distribution between tractor and soil tillage implement can be adjusted or changed, folding mechanisms, by means of which a width of the soil tillage implement can be reduced to a value that is permissible for public roads or increased to a value that is efficient for the soil tillage as well as additional tools for levelling tools, rollers, in particular depth guiding rollers, flexible harrows and the like can be particularly advantageous for such soil tillage tools in connection with the present invention. Thus, the invention is particularly suitable for such soil tillage implements comprising corresponding mechanisms.

From EP 3 122 168 A1 a soil tillage implement with disc tools is known, in which the individual discs are fastened to a frame and are distributed over the frame area defined by the frame. Disadvantageous in this soil tillage implement is its expansive design, which is the result in particular of the running gear being arranged only behind the frame. Among other things, this configuration results in that a combination of tractor and soil tillage implement has a large turning circle, which results in inefficient working in particular when turning on the field.

There are other solutions of soil tillage implements in which the running gear is arranged in front of a downstream depth guiding roller, as a result of which the turning ability of the combination is improved. Such a solution is described in EP 3 152 990 A1. Similar approaches also exist with cultivators. These implements however have the disadvantage among others that the arrangement of the cultivator tines or other soil tillage tools across the frame is not selected so that a high quality even tillage of the soil is possible.

Before this background an object of the present invention consists in providing a soil tillage implement having soil tillage tools in which the soil tillage tools are arranged so that a high manoeuvrability, neat connecting runs and an even soil tillage can be achieved. A further object of the invention lies in achieving an optimal installation space utilisation of the frame area in order to be able to produce the implement in as compact and efficient as possible a manner.

This object is solved through the soil tillage implement according to claim 1 or 2. Advantageous further developments of the invention are obtained from the sub-claims.

A soil tillage implement of the above technical area having soil tillage tools, in particular disc tools, which are arranged in multiple consecutive tool rows in the working direction oriented transversely to the working direction, and having a running gear with at least one main wheel that is spaced apart from a centre longitudinal axis by a lateral wheel distance transversely to the working direction, wherein the running gear is arranged with respect to the soil tillage tools in such a manner that with respect to the working direction in front of as well as to the left and right of the running gear at least one soil tillage tool is arranged, is configured according to the invention so that all soil tillage tools, which are arranged in the tool row located furthest in front of the running gear in the working direction, have a lateral tool distance from the centre longitudinal axis that is smaller or equal to the lateral wheel distance.

Because of the fact that all soil tillage tools arranged in the tool row located furthest in front of the running gear in the working direction have a lateral tool distance from the centre longitudinal axis that is smaller or equal to the lateral wheel distance, the soil tillage tools can be moved further towards the front relative to the tool rows extending over the entire working width, without having a disadvantageous effect on the manoeuvrability of the soil tillage implement. From this arises the possibility of integrating the running gear into the tool rows. The soil tillage tools which with even and symmetrical arrangement in each row are otherwise located in the place of the running gear, i.e. in particular the place of the one main wheel or of the multiple main wheels as well as between the main wheels, can be arranged in front of the front-most complete row and, provided these are arranged according to the invention, can be arranged without negatively affecting manoeuvrability, evenness or freedom of side draft.

In other words, based for example on a two-row disc harrow with soil tillage tools arranged symmetrically to the centre longitudinal axis, multiple soil tillage tools in the centre are moved forward in front of the previous front-most row in order to create space in the middle for the running gear and without worsening the manoeuvrability of the combination or the evenness and quality of the tillage at the same time.

In the present context, a main wheel or multiple main wheels is to mean in particular the wheel or the wheels which in contrast with one or multiple support wheels continuously absorb/s a greater weight force during the utilisation of the soil tillage implement or at least during transport or turning operations.

The abovementioned wheel distance is to mean the distance between an outer edge of the main wheel and the centre longitudinal axis. The width of the main wheel concerned is thus included in the wheel distance. Similar applies to the tool distance in the present context which means the distance between an outer edge of the tool concerned and the centre longitudinal axis.

The feature according to which all soil tillage tools, which are arranged in the tool row located furthest in front of the running gear in the working direction, have a lateral tool distance from the centre longitudinal axis that is smaller or equal to the lateral wheel distance is thus fulfilled in particular when all of the mentioned soil tillage tools are situated at a distance interval between the centre longitudinal axis and the edge of the main wheel or of the (outermost) main wheels facing away from the centre longitudinal axis within the frame area.

By way of the arrangement according to the invention it is not only ensured that the manoeuvrability of the implement, freedom of side draft when utilising the implement and evenness of the tillage are achieved. It also makes possible a high degree of stability since the front-most soil tillage tools, seen in the working direction, are located in the front region of a triangle between the outermost contact points of the running gear and the support point of the soil tillage implement on a tractor or the like, for example at the end of a tow bar of the soil tillage implement. Thus, the running gear can guide the soil tillage in a stable manner.

Preferably, the running gear comprises two main wheels which are each spaced apart from the centre longitudinal axis by the same lateral wheel distance. By way of two main wheels, the stability of the soil tillage implement about the longitudinal axis can be increased without rendering a particularly wide main wheel necessary.

A further soil tillage tool according to the invention comprises a centre longitudinal axis, soil tillage tools, in particular disc tools, which are arranged in multiple consecutive tool rows in the working direction oriented transversely to the working direction, and a running gear having at least two main wheels spaced apart transversely to the working direction. The running gear is arranged with respect to the soil tillage tools in such a manner that with respect to the working direction in front of as well as to the left and right of the running gear at least one soil tillage tool is arranged, so that the running gear interrupts at least one of the tool rows over a running gear width extending transversely to the working direction, wherein a tool row that is arranged furthest in front of the running gear in the working direction extends transversely to the working direction over not more than the running gear width.

In connection with this soil tillage implement according to the invention it should be noted that the running gear width is defined by the region transversely to the working direction over which the tool row interrupted by the running gear is tool-free, i.e. the number of soil tillage tools that are missing in the region of the running gear compared with a consistent continuation of the tool row and where these missing soil tillage tools would be arranged with consistent continuation of the tool row.

In other words, a soil tillage tool array is removed from the tool row laterally surrounding the running gear and placed in front of the otherwise front-most tool row. Accordingly, the running gear can be moved towards the front in the working direction compared with a position as in EP 3 122 168 A1, which shortens the wheelbase, i.e. the distance between the running gear and a tow bar or the rear axle of a tractor and improves the manoeuvrability of the combination without diminishing the quality of the soil tillage because the soil tillage tools giving way to the running gear are arranged in front of the otherwise front-most tool row and thus not omitted.

For levelling the working pattern left behind by the soil tillage tools, levelling tools can be employed behind the soil tillage tools in the fundamentally known manner. Rollers, guide plates and/or flexible harrows, for example are suitable for this purpose.

Regarding a definition of a tool row it should be noted furthermore that a soil tillage tool, which compared with other soil tillage tools of a tool row is moved in the working direction by up to half a distance between consecutive tool rows, is still considered as belonging to that tool row.

In a preferred embodiment, the same number of soil tillage tools is arranged on both sides outside the centre longitudinal axis. This means that for example in the case of an uneven number of soil tillage tools per row, soil tillage tools can also be arranged centrally, i.e. on the centre longitudinal axis. In this way it can be readily achieved that no side draft by the soil tillage implement occurs.

Preferably, at least one front support wheel each is arranged with respect to the working direction to the left and right next to the tool row located furthest in front of the running gear in the working direction and in the same position along the working direction as the said tool row, so that the soil tillage tools of that tool row are flanked by the front support wheels.

By way of the support wheels, the stability of the soil tillage implement is increased and the depth guidance of the soil tillage tools can also take place next to the running gear, i.e. the main wheels and/or a depth guiding roller, with the help of the support wheels. When one or more support wheels or one or more depth guiding roller(s) is/are arranged behind the main wheel there is the possibility of offsetting a negative support load during the work. For this it is preferred that the support wheel or the support wheels or the depth guiding roller(s) is or are arranged approximately 30 cm behind the main wheel or the main wheels. This distance makes possible realising this effect without having to generate particularly great forces through the support wheel or the support wheels or depth guiding roller(s) when the lever arm between support wheel/depth guiding roller and main wheel is small and without having to give up the advantage of a compact design when the lever arm between support wheel/depth guiding roller and main wheel becomes large.

In a preferred embodiment of the invention, some soil tillage tools are arranged on a middle frame segment and two or more soil tillage tools of these form the tool row located furthest in front of the running gear in the working direction. Further, a plurality of soil tillage tools each are preferably arranged on a left lateral frame segment and a right lateral frame segment. The lateral frame segments are preferably each foldable relative to the middle frame segment about a folding axis preferably running parallel to the working direction in order to switch the soil tillage implement between a working position and a transport position, and the running gear is preferably arranged on the middle frame segment and support wheels are optionally arranged on the lateral frame segments. At the same time, an adaptation of the lateral parts for maintaining the working depth transversely to the main working direction with uneven terrain/soil surface is achieved.

This preferred distribution of soil tillage tools leads to an even and efficient soil tillage because the soil tillage implement can be configured symmetrically, highly manoeuvrable and compact and nevertheless furnished with a large working width.

Further it is preferred that the soil tillage tools located laterally furthest away from the centre longitudinal axis of the tool row located furthest in front of the running gear are arranged in the working direction aligned in front of the main wheels of the running gear. This configuration results in that earth thrown up by the soil tillage tools gets in front of the main wheels of the running gear and is compacted by these which altogether has a more even soil tillage as a consequence since the main wheels otherwise compact the soil formed without additional earth and can thus lead to tracking grooves without alternative or additional counter-measures.

In a preferred embodiment, the soil tillage tools are arranged obliquely and are preferentially hollow discs by way of which a throwing direction each is defined, wherein the throwing direction of the soil tillage tools of the rear-most tool row points towards the centre longitudinal axis, the throwing direction of the soil tillage tools of the tool rows arranged one behind the other alternately point away from the centre longitudinal axis and towards the centre longitudinal axis.

In other words, in particular with an arrangement of tillage tools that is mirror-symmetrical to the centre longitudinal axis, a directional change of the throwing direction of the soil tillage tools can take place along the working direction from row to row.

By way of this configuration and arrangement of the soil tillage tools a preferably even yet efficient soil tillage through the soil tillage tools can be achieved. The piling up of earth in the middle or at the edges of the working width (dam formation) often problematic in the prior art can be bypassed through the present preferred arrangement of the soil tillage tools because the front-most tool row and the tool row in which the running gear is also positioned, runs only over a part of the total working width of the soil tillage implement.

Preferably, a depth guidance of the soil tillage tools is effected via the main wheel or the main wheels of the running gear and/or a depth guiding roller or multiple depth guiding rollers, wherein support wheels that may be present can support during this depth guidance. The depth guiding roller is or the depth guiding rollers are preferentially arranged in the working direction behind the running gear in order to assume a favourable lever position for generating the force on the subsoil necessary for the depth guidance. Since the depth guiding roller is not required for supporting the soil tillage implement it has no negative effects behind the running gear on the manoeuvrability of the soil tillage implement or combination consisting of the soil tillage implement and a tractor.

However it is also possible to arrange a roller arranged behind the running gear with a width of up to the running gear width further at the front than rollers or roller parts outside the range of the running gear width, i.e. with a larger lateral distance from the centre longitudinal axis.

One or more rollers and/or one or more flexible harrows can continue to be arranged as levelling tools behind the soil tillage tools.

In a preferred embodiment, at least one of the additional tools, which is located on the centre longitudinal axis or directly adjacent to the same, is moved relative to the other additional tools of its additional tool row in the working direction towards the front or rear, preferentially by ⅓-times to ½-times its longitudinal extension along the working direction. At the same time, the moving dimension is preferably 30% or more, further preferably 50% or more of a diameter of the additional tool when the same is disc-shaped. Accordingly, a risk of clogging that otherwise exists through material being wrapped about the additional tools in the case of additional tools located near one another can be reduced or prevented.

Through the present invention a soil tillage implement with soil tillage tools is provided, in which the soil tillage tools are arranged so that a high degree of manoeuvrability, neat connecting runs and an even soil tillage can be achieved. An optimal installation-utilisation of the frame area is achieved in order to be able to produce the implement as compact and efficient as possible.

Further advantages and further developments of the invention are obtained from the following figure description and the entirety of the claims.

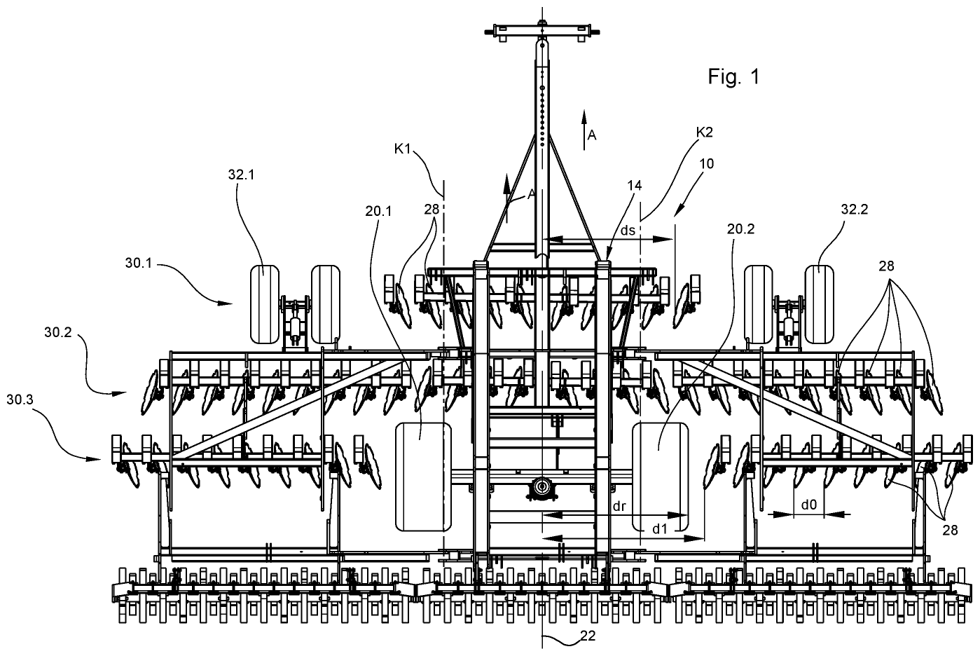

FIG. 1 shows a plan view of a soil tillage implement in a first preferred embodiment.

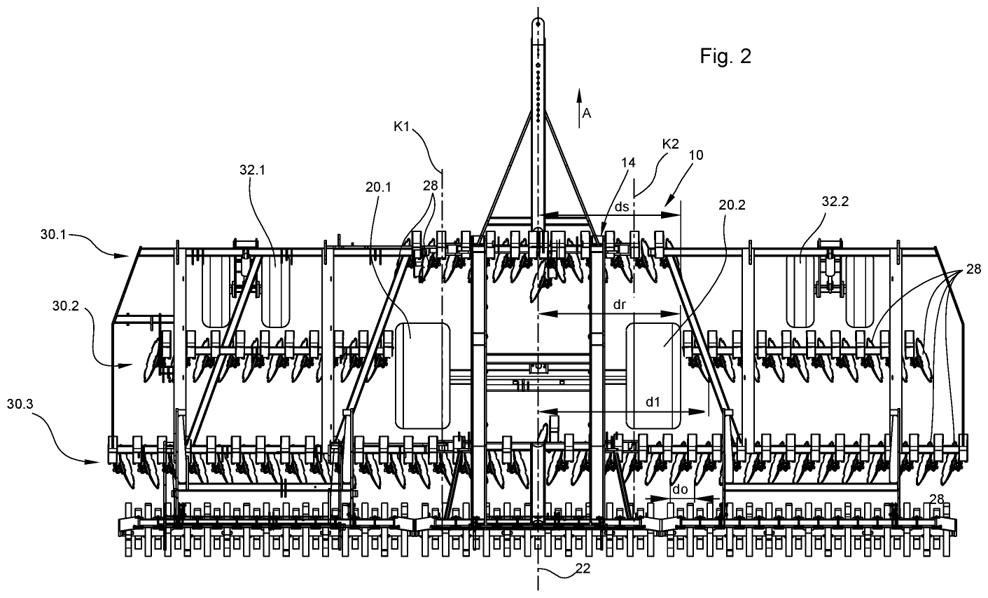

FIG. 2 shows a plan view of the soil tillage implement in a second preferred embodiment.

In the following description, same reference numbers are used for same or corresponding elements and a repetitive description is largely avoided.

FIG. 1 shows a plan view of a disc harrow 10 in a first preferred embodiment. The disc harrow 10 comprises a frame 14 with a middle frame segment, a left lateral frame segment and a right lateral frame segment on which a plurality of hollow discs 28 are arranged over a frame area. The directions left and right are based on a working direction A, in which the disc harrow 10 is pulled during its working operation. For this purpose, the disc harrow 10 is coupled to a tractor via a tow bar in the known manner. The lateral frame segments are movably interconnected with the middle frame segment via folding axles K1 and K2 and can be brought, preferentially via actuators, from a laterally extending working position into a vertical transport position.

In order to support the load of the disc harrow 10, a running gear is integrated in the frame 14. The running gear includes two main wheels 20.1, 20.2 that are equidistantly spaced apart the same distance to the left and right from a centre longitudinal axis 22, which have a lateral wheel distance dr from the centre longitudinal axis 22 and support the middle frame segment via an axle. Complementarily to the running gear, the disc harrow additionally includes a pair of front support wheels 32.1, 32.2. Through the hinge effect of the folding axles K1 and K2, an adaptation of the working depth of the respective frame segments to soil irregularities that occur transversely to the main working direction can take place with the help of the support wheels 32.1, 32.2 and with the help of the actuators.

The hollow discs 28 in the present embodiment are arranged in three tool rows 30.1, 30.2, 30.3, which run transversely to the working direction A and are arranged one behind the other in the working direction A. Behind the rear-most tool row 30.3, whose lateral extent defines a total working width of the disc harrow 10, depth guiding rollers are additionally provided and levelling tools or other additional tools can be additionally provided.

In the rear-most tool row 30.3, sixteen hollow discs 28 each at the same lateral tine spacing d0 from one another are arranged, wherein eight hollow discs 28 are arranged to the left of the centre longitudinal axis 22 and eight hollow discs 28 to the right of the centre longitudinal axis 22.

In the middle of the rear-most tool row 30.3 is located the running gear with its main wheels 20.1, 20.2 so that the running gear interrupts the rear-most tool row 30.3 over a running gear width extending transversely to the working direction A. In the embodiment shown in FIG. 1, the running gear width extends on both sides of the centre longitudinal axis 22 by a tool row distance dl from the centre longitudinal axis 22. In other words, the rear-most tool row 30.3 misses a plurality of hollow discs 28 that would have to be arranged in the region of the running gear width if the rear-most tool row 30.3 were continued consistently. In the embodiment shown in FIG. 1, these hollow discs 28 form the tool row 30.1 located furthest in front of the running gear in the working direction A. From a designer's view, the hollow discs 28 from the middle region of the rear-most tool row 30.3, in which the main wheels 20.1, 20.2 are located and which extends over the running gear width on both sides of the centre longitudinal axis 22 by the tool row distance dl, are positioned in front of the otherwise front-most tool row 30.2, which thus becomes the middle tool row 30.2. Thus tool rows 30.1, 30.2, 30.3 remain, wherein the rear-most tool row 30.3 with its two lateral disc arrays and the front-most tool row 30.1 with its middle disc array complement one another to form a complete tool row.

The depth guiding roller following behind the rear-most tool row 30.3 in the working direction A is mounted, like the tool rows 30.1, 30.2, 30.3 on the segments of the frame 14 and can be brought with the hollow discs 28 of the individual tool rows 30.1, 30.2, 30.3 into the vertical transport position in that the lateral frame segments are folded up about the folding axles K1, K2.

The hollow discs 28 of the tool rows 30.1, 30.2, 30.3 each define a throwing direction. The hollow discs 28 of the rear-most tool row 30.3 are aligned and arranged so that its throwing direction points to the inside towards the centre longitudinal axis 22.

In front of the rear-most tool row 30.3, the continuous middle tool row 30.2 substantially running over the entire working width is arranged. The hollow discs 28 of the middle tool row 30.2 have a throwing direction that points towards the outside away from the centre longitudinal axis 22.

Again in front of the middle tool row 30.2 the front-most tool row 30.1 is arranged, wherein the throwing direction of the hollow discs 28 of the front-most tool row 30.1 like that of the hollow discs 28 of the rear-most tool row 30.3 points to the inside towards the centre longitudinal axis 22. It is true for the hollow discs 28 of the front-most tool row 30.1 that a lateral disc distance ds of all hollow discs 28 to the centre longitudinal axis 22 is smaller or equal to the wheel distance dr. Alternatively and additionally it is possible to select the lateral extent of the front-most tool row 30.1 so that the lateral disc distance ds of all hollow discs 28 to the centre longitudinal axis 22 is smaller than the tool row distance dl, which corresponds to the distance of the hollow discs 28 of the rear-most tool row 30.3 located next to the centre longitudinal axis 22. Thus, the front-most tool row 30.1 is a part tool row which in the present embodiment extends over less than half of the full working width of the disc harrow 10.

This preferred embodiment makes possible to arrange very evenly a plurality of hollow discs 28 of a disc harrow 10 in a compact frame 14 with integrated running gear and thus a high degree of manoeuvrability, so that a highly homogeneous working pattern is created and thus a high-quality soil tillage is possible. By selecting and distributing the throwing directions of the hollow discs 28 over the tool rows 30.1 . . . 30.3, a symmetrical and even tillage of the soil is possible.

FIG. 2 shows a plan view of a soil tillage implement in a second preferred embodiment. A large part of the elements shown in FIG. 2 is equal to those of the first preferred embodiment shown in FIG. 1. This first preferred embodiment from FIG. 1 is changed according to the second preferred embodiment from FIG. 2 in that the running gear with the main wheels 20.1, 20.2 is arranged in the middle of the middle tool row 30.2 so that the running gear interrupts the middle tool row 30.2 over the running gear width extending transversely to the working direction A.

In the working direction A behind the interrupted middle tool row 30.2 the rear-most tool row 30.3 as continuous tool row 30.3 is formed. Otherwise, the features of the first embodiment from FIG. 1 are analogously realised also in the embodiment from FIG. 2.

This preferred embodiment also makes it possible to very evenly arrange a plurality of hollow discs 28 of a disc harrow 10 in a compact frame 14 with integrated running gear and thus a high degree of manoeuvrability, so that a highly homogeneous working pattern is created and thereby a higher-quality soil tillage is possible. By selecting and distributing the throwing directions of the hollow discs 28 over the tool rows 30.1 . . . 30.3, a symmetrical and even soil tillage is possible.

LIST OF REFERENCE NUMBERS

| | |
|---|---|
| 10 | Soil tillage implement, disc harrow |
| 12 | Frame |
| 20.1, 20.2 | Main wheel |
| 22 | Centre longitudinal axis |
| 28 | Soil tillage tools |
| 30.1 . . . 30.2 | Tool rows |
| 32.1, 32.2 | Front-most support wheel |
| A | Working direction |
| dr | Wheel distance |
| ds | Disc distance |
| d0 | Tine spacing |
| d1 | Tool row distance |

1. A soil tillage implement (10) having soil tillage tools (28), in particular disc tools, which are arranged in multiple tool rows (30.1 . . . 30.3) following one another in the working direction (A) which are oriented transversely to the working direction (A), and
a running gear having at least one main wheel (20.1, 20.2) which is spaced apart from a centre longitudinal axis (22) by a lateral wheel distance (dr) transversely to the working direction (A), wherein the running gear is arranged relative to the soil tillage tools (28) in such a manner that with respect to the working direction (A) at least one soil tillage tool (28) is arranged in front and to the left and right of the running gear,
wherein all soil tillage tools (28) which are arranged in the tool row (30.1) located furthest in front of the running gear in the working direction (A), have a lateral tool distance (dw) from the centre longitudinal axis (22) that is smaller or equal to the lateral wheel distance (dr).

2. The soil tillage implement (10) having a centre longitudinal axis (22), soil tillage tools (28) in particular disc tools, which are arranged in multiple tool rows (30.1, 30.3) following one another in the working direction (A) and which are oriented transversely to the working direction (A),
and
a running gear having at least two main wheels (20.1, 20.2) spaced apart transversely to the working direction (A),
wherein the running gear is arranged with respect to the soil tillage tools (28) in such a manner that with respect to the working direction (A) at least one soil tillage tool (28) is arranged in front of and to the left and right of the running gear, so that the running gear interrupts at least one of the tool rows (30.1 . . . 30.3) over a running gear width extending transversely to the working direction (A),
wherein a tool row (30.1 . . . 30.3) arranged furthest in front of the running gear in the working direction (A) extends transversely to the working direction (A) over not more than the running gear width.

3. The soil tillage implement (10) according to claim 1,
wherein the running gear comprises two main wheels (20.1, 20.2) which are each spaced apart from the centre longitudinal axis (22) by the same lateral wheel distance (dr).

4. The soil tillage implement (10) according to claim 1, wherein on both sides outside the centre longitudinal axis (22) the same number of soil tillage tools (28) is arranged.

5. The soil tillage implement (10) according to claim 1,
wherein with respect to the working direction (A) at least one front support wheel (32.1, 32.2) each is arranged with respect to the working direction (A) to the left and right next to the tool row (30.1) located furthest in front of the running gear in the working direction (A) and in the same position as this tool row (30.1) along the working direction (A), so that the soil tillage tools (28) of this tool row (30.1) are flanked by the front support wheels (32.1, 32.2).

6. The soil tillage implement (10) according to claim 1,
wherein some soil tillage tools (28) are arranged on a middle frame segment and of these two or more soil tillage tools (28) form the tool row (30.1) located furthest in front of the running gear in the working direction (A) and
wherein preferably a plurality of soil tillage tools (28) each are arranged on a left lateral frame segment and a right lateral frame segment,
wherein the lateral frame segments are each preferably foldable relative to the middle frame segment about a folding axis running parallel to the working direction (A), in order to switch the soil tillage implement (10) between a working position and a transport position,
wherein preferably the running gear is arranged on the middle frame segment and wherein optionally support wheels (32.1, 32.2) are arranged on the lateral frame segments.

7. The soil tillage implement (10) according to claim 1,
wherein the soil tillage tools (28) located laterally furthest away from the centre longitudinal axis (22) of the tool row (30.1) located furthest in front of the running gear are arranged aligned in front of the main wheels (20.1, 20.2) of the running gear in the working direction (A).

8. The soil tillage implement (10) according to claim 1,
wherein the soil tillage tools (28) are arranged obliquely and are preferentially hollow discs by way of which a throwing direction each is defined,
wherein the throwing direction of the soil tillage tools (28) of the rear-most tool row (30.3) points towards the centre longitudinal axis (22) and
wherein the throwing directions of the soil tillage tools (28) of the tool rows (30.1, 30.2, 30.3) arranged one behind the other alternately point away from the centre longitudinal axis 22) and towards the centre longitudinal axis (22).

9. The soil tillage implement (10) according to claim 1,
wherein at least one of the soil tillage tools (28), which is situated on the centre longitudinal axis (22) or directly adjacent to the same, is moved relative to the other soil tillage tools (28) of its tool row (30.1, 30.2, 30.3) to the front or rear in the working direction (A), preferentially by ⅓-times to ½-times its longitudinal extent along the working direction (A).

10. The soil tillage implement (10) according to claim 1, wherein in the working direction (A) behind the running gear a one-part or multi-part depth guiding roller is arranged.
